(19) United States
(12) Patent Application Publication
(10) Pub. No.: US 2014/0071202 A1
(43) Pub. Date: Mar. 13, 2014

(54) INKJET PRINT HEAD

(71) Applicant: SAMSUNG ELECTRO-MECHANICS CO., LTD., Suwon (KR)

(72) Inventors: Byung Hun KIM, Suwon (KR); Hwa Sun LEE, Suwon (KR)

(73) Assignee: SAMSUNG ELECTRO-MECHANICS CO., LTD., Suwon (KR)

(21) Appl. No.: 13/705,346

(22) Filed: Dec. 5, 2012

(30) Foreign Application Priority Data
Sep. 11, 2012 (KR) 10-2012-0100677

(51) Int. Cl. B41J 2/045

(52) U.S. Cl. CPC B41J 2/045
USPC 347/44

(57) ABSTRACT

There is provided an inkjet print head, including: a first channel to which ink is supplied; a second channel disposed in parallel with the first channel and recovering ink; a pressure chamber disposed between the first channel and the second channel; an ink supply route connecting the first channel to the pressure chamber; and an ink discharge route connecting the pressure chamber to the second channel.

### CROSS-REFERENCE TO RELATED APPLICATIONS

This application claims the priority of Korean Patent Application No. 10-2012-0100677 filed on Sep. 11, 2012, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head capable of improving ink discharge efficiency through ink circulation.

2. Description of the Related Art

An inkjet print head may print a desired image, pattern or text by discharging finely-sized ink droplets (or a liquid phase material in certain other industries) through a nozzle.

However, the inkjet print head may have reduced ink discharge performance after a long period of operation. For example, foreign objects or bubbles included in ink may hinder the discharge thereof through the nozzle and as a result, the ink discharge efficiency of the inkjet print head may be degraded.

Therefore, there is a need to develop an inkjet print head capable of reducing the degradation in discharge efficiency thereof due to foreign objects or bubbles included in ink.

Meanwhile, as inkjet print head related art, there are provided Patent Documents 1 and 2. Patent Documents 1 and 2 disclose one type of inkjet print head having an ink circulation structure. However, the inventions of Patent Documents 1 and 2 only describe a conceptual structure of an ink circulation structure, and therefore, are difficult to be substantially applied to an inkjet print head.

### RELATED ART DOCUMENT

(Patent Document 1) JP2012-011629 A
(Patent Document 2) JP2012-011653 A

### SUMMARY OF THE INVENTION

An aspect of the present invention provides an inkjet print head able to be practically applied to an inkjet print head while improving ink discharge efficiency thereof by smoothly circulating ink therein.

According to an aspect of the present invention, there is provided an inkjet print head, including: a first channel to which ink is supplied; a second channel disposed in parallel with the first channel and recovering ink; a pressure chamber disposed between the first channel and the second channel; an ink supply route connecting the first channel to the pressure chamber; and an ink discharge route connecting the pressure chamber to the second channel.

The ink supply route may be gradually narrowed in a direction toward the pressure chamber from the first channel.

The ink discharge route may be gradually narrowed in a direction toward the second channel from the pressure chamber.

The ink supply route may be located below the ink discharge route within the inkjet print head.

The ink supply route may be provided with a first structure impeding a flow of ink from the pressure chamber to the first channel.

The first structure may be gradually expanded in a direction toward the pressure chamber from the first channel.

The ink discharge route may be provided with a second structure impeding a flow of ink from the second channel to the pressure chamber.

The second structure may be gradually expanded in a direction toward the second channel from the pressure chamber.

According to another aspect of the present invention, there is provided an inkjet print head, including: a pair of first channels to which ink is supplied; a second channel disposed between the pair of first channels and recovering ink; and a plurality of pressure chambers disposed between the first and second channels and connected to the first and second channels, respectively.

An ink supply route connecting the first channel to the pressure chamber may be gradually narrowed in a direction toward the pressure chamber from the first channel.

An ink discharge route connecting the pressure chamber to the second channel may be gradually narrowed in a direction toward the second channel from the pressure chamber.

An ink supply route connecting the first channel to the pressure chamber may be provided with a first structure impeding a flow of ink from the pressure chamber to the first channel.

The first structure may be gradually expanded in a direction toward the pressure chamber from the first channel.

An ink discharge route connecting the pressure chamber to the second channel may be provided with a second structure impeding a flow of ink from the second channel to the pressure chamber.

The second structure may be gradually expanded in a direction toward the second channel from the pressure chamber.

An upper portion of the second channel may be provided with a driving element driving an actuator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an inkjet print head according to a first embodiment of the present invention;

FIG. 2 is a diagram illustrating a transverse sectional shape of an ink supply route illustrated in FIG. 1;

FIG. 3 is a diagram illustrating another transverse sectional shape of the ink supply route illustrated in FIG. 1;

FIG. 4 is a diagram illustrating another transverse sectional shape of the ink supply route illustrated in FIG. 1;

FIG. 5 is a cross-sectional view of an inkjet print head according to a second embodiment of the present invention;

FIG. 6 is a diagram for illustrating main elements of an inkjet print head according to a third embodiment of the present invention;

FIG. 7 is a cross-sectional view of an inkjet print head according to a fourth embodiment of the present invention; and

FIG. 8 is a plan view of the inkjet print head illustrated in FIG. 7.

### DETAILED DESCRIPTION OF THE EMBODIMENTS

In an inkjet print head according to the related art, since ink only flows in one direction (to a nozzle from a channel), the nozzle can be easily blocked due to foreign objects or bubbles included in the ink.

An embodiment of the present invention is to solve the problem above, wherein a pressure chamber is disposed between two channels to circulate ink within the inkjet print head.

The embodiment of the present invention has an ink circulation structure continuously circulating ink to relieve a phenomenon of concentration of foreign objects or bubbles on the nozzle, thereby reducing a blocking phenomenon of the nozzle.

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

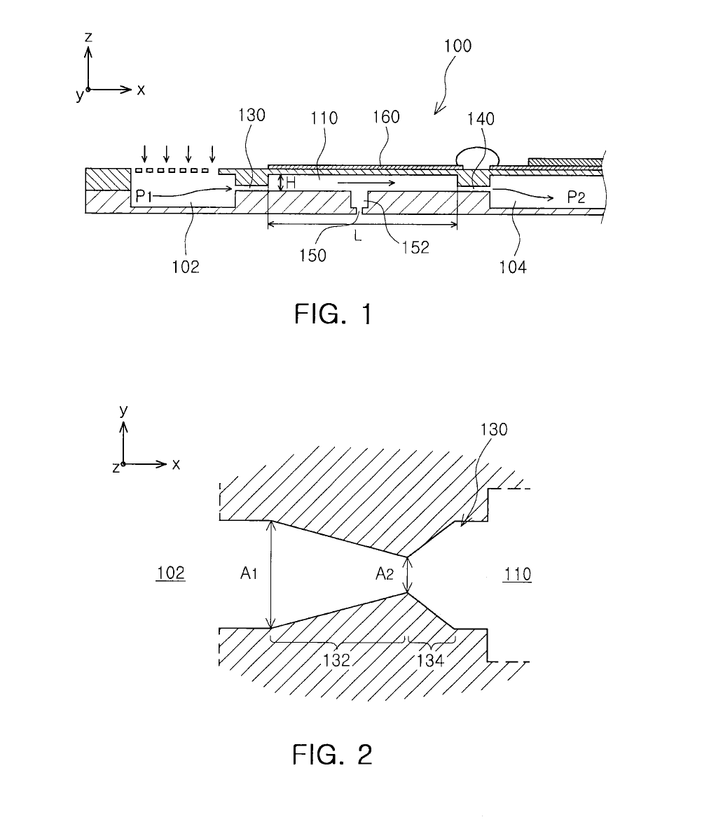

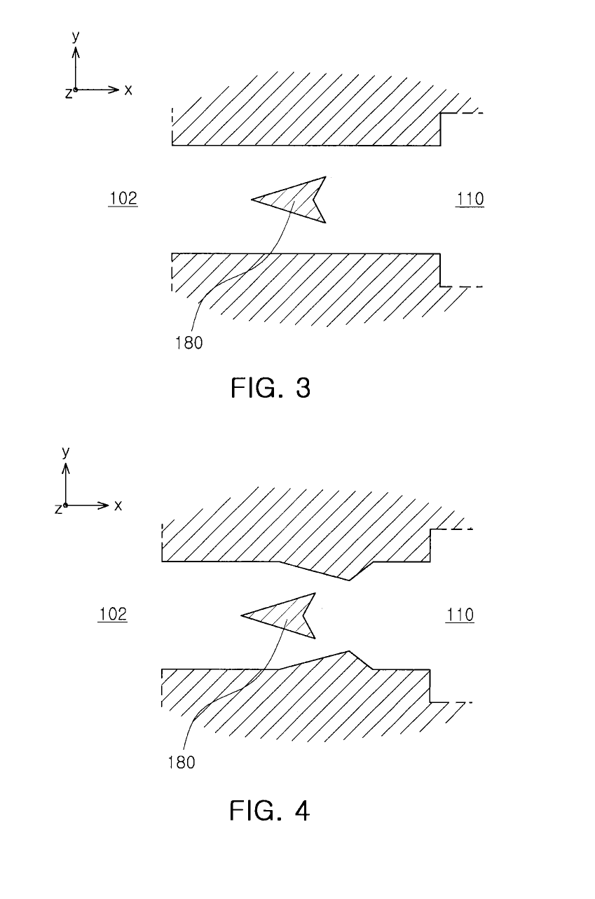

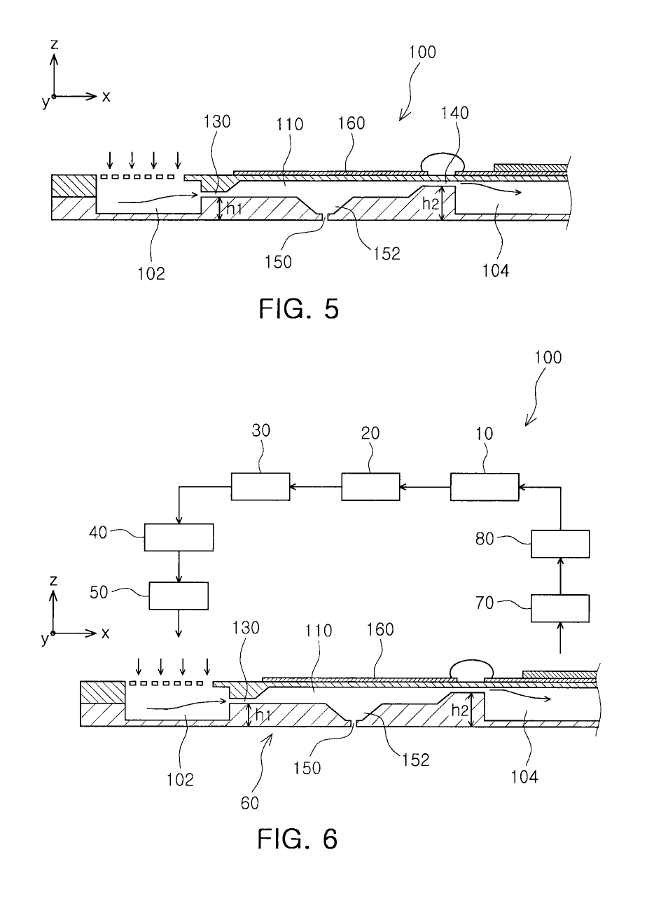

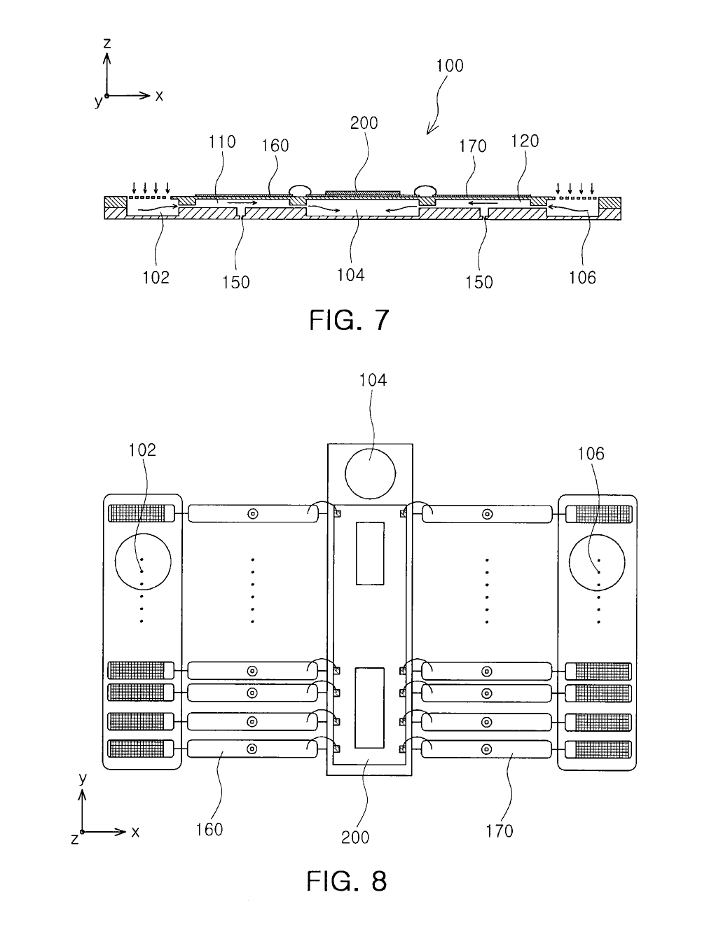

FIG. 1 is a cross-sectional view of an inkjet print head according to a first embodiment of the present invention, FIG. 2 is a diagram illustrating a transverse sectional shape of an ink supply route illustrated in FIG. 1, FIG. 3 is a diagram illustrating another transverse sectional shape of the ink supply route illustrated in FIG. 1, FIG. 4 is a diagram illustrating another transverse sectional shape of the ink supply route illustrated in FIG. 1, FIG. 5 is a cross-sectional view of an inkjet print head according to a second embodiment of the present invention, FIG. 6 is a diagram for illustrating main elements of an inkjet print head according to a third embodiment of the present invention, FIG. 7 is a cross-sectional view of an inkjet print head according to a fourth embodiment of the present invention, and FIG. 8 is a plan view of the inkjet print head illustrated in FIG. 7.

The inkjet print head according to the first embodiment of the present invention will be described with reference to FIGS. 1 through 4.

An inkjet print head 100 according to the first embodiment of the present invention may include a first channel 102, a second channel 104, a pressure chamber 110, an ink supply route 130, an ink discharge route 140, and a nozzle 150. Further, the inkjet print head 100 may further include other members including an actuator 160.

The first channel 102 may be extended in a first direction (a Y-axis direction of FIG. 1) of the inkjet print head 100. The first channel 102 formed as described above may be connected to an ink tank 10 (see FIG. 6) in which ink is stored.

Therefore, ink may be continuously supplied through the first channel 102.

A predetermined amount of first pressure P1 may be formed in the first channel 102. The first pressure P1 may be higher than an atmospheric pressure. Further, the first pressure P1 may be higher than a pressure of the pressure chamber 110. Therefore, the ink of the pressure chamber 110 may move to the second channel 104 without flowing back to the first channel 102.

The second channel 104 may be extended in the first direction (the Y-axis direction of FIG. 1) of the inkjet print head 100. That is, the second channel 104 may be formed in parallel with the first channel 102. The second channel 104 formed as described above may be connected to an ink recovery tank in which ink is recovered or an ink tank 10 (see FIG. 6). Therefore, ink is recovered through the second channel 104 and may be reintroduced to the ink tank 10.

A predetermined amount of second pressure P2 may be formed in the second channel 104. The second pressure P2 may be lower than an atmospheric pressure. Further, the second pressure P2 may be lower than the pressure of the pressure chamber 110. Therefore, the ink of the pressure chamber 110 may move to the second channel 104 without flowing back to the first channel 102.

The pressure chamber 110 may be disposed between the first channel 102 and the second channel 104. Further, the pressure chamber 110 may be connected to the first channel 102 and the second channel 104.

The pressure chamber 110 may store ink supplied from the first channel 102. To this end, the pressure chamber 110 may have a predetermined volume. For example, the pressure chamber 110 may have a volume equal to or greater than a volume of an ink drop that is discharged once through the nozzle 150.

The pressure chamber 110 may have a substantially rectangular parallelepiped shape. For example, the pressure chamber 110 may have a rectangular sectional shape that extends lengthwise in a second direction (the X-axis direction of FIG. 1) of the inkjet print head 100. Here, a height (a Z-axis direction of FIG. 1; H) of the pressure chamber 110 and a length (the X-axis direction of FIG. 1; L) thereof may have a predetermined ratio therebetween. In detail, a ratio H/L may be smaller than 1. As such, when the ratio H/L is smaller than 1, the ink in the pressure chamber 110 may be effectively discharged through the nozzle 150, even when a small amount of pressure is applied to the pressure chamber 110.

The ink supply route 130 may connect the first channel 102 to the pressure chamber 110. Therefore, the ink of the first channel 102 may be supplied to the pressure chamber 110 through the ink supply route 130.

The ink supply route 130 may permit the flow of ink to the pressure chamber 110 from the first channel 102 or interrupt or reduce the flow of ink to the first channel 102 from the pressure chamber 110. To this end, the ink supply route 130 may have a transverse sectional shape illustrated in FIGS. 2 through 4.

The ink supply route 130 according to the embodiment of the present invention may have a shape in which a cross-sectional area is narrowed in the direction toward the pressure chamber 110 from the first channel 102 as illustrated in FIG. 2. That is, a width A1 of an inlet (left of FIG. 2) of the ink supply route 130 may be larger than a width A2 of an outlet (right of FIG. 2) of the ink supply route 130.

In addition, the ink supply route 130 may have a first section 132 in which a cross-sectional area is narrowed in the direction toward the pressure chamber 110 and a second section 134 in which a cross-sectional area is increased toward the pressure chamber 110. Here, a length of the first section 132 may be longer than a length of the second section 134. Further, the second section 134 may be omitted, if necessary.

The ink supply route 130 having another shape may include a first structure 180 impeding the flow of ink from the pressure chamber 110 to the first channel 102 as illustrated in FIG. 3. The first structure 180 may be expanded in direction of the outlet of the ink supply route 130 from the inlet thereof. For example, the transverse section of the first structure 180 may have a substantially triangular shape.

The ink supply route 130 having another shape may have a gradually reduced section and include the first structure 180 impeding the flow of ink. In other words, the ink supply route 130 may be gradually narrowed in the direction toward the pressure chamber 110 from the first channel 102 as illustrated in FIG. 4 and the ink supply route 130 may be provided with the first structure 180, expanded in the direction of the outlet of the ink supply route 130 from the inlet thereof. The first structure 180 may hinder the flow of ink from the outlet of the ink supply route 130 to the inlet thereof.

The ink supply route 130 having the foregoing shape only permits the flow of ink (that is, the flow of ink from the first channel 102 to the pressure chamber 110) in one direction and therefore, counter-flow of the ink from the pressure chamber 110 to the first channel 102 may be effectively suppressed.

The ink discharge route 140 may permit the flow of ink from the pressure chamber 110 to the second channel 104 or interrupt or reduce the flow of ink from the second channel 104 to the pressure chamber 110. To this end, the ink discharge route 140 may have the same shape as or a similar shape to the transverse sectional shape of the ink discharge route 140 illustrated in FIGS. 2 through 4. That is, second structure may be formed in the ink discharge route 140.

The ink supply route 130 and the ink discharge route 140 having the foregoing shape only allow ink to move in one direction, and therefore, the ink circulation structure moving from the first channel 102 to the second channel 104 via the pressure chamber 110 may be implemented.

The nozzle 150 may be formed in the pressure chamber 110. The nozzle 150 formed as described above may discharge the ink stored in the pressure chamber 110 to the outside.

A damper 152 may be formed between the nozzle 150 and the pressure chamber 110. The damper 152 may relieve the phenomenon of a sudden concentration of the ink in the pressure chamber 110 on the nozzle 150. To this end, the damper 152 may have a sectional area gradually narrowed in the direction toward a lower portion (z-axis direction of FIG. 1) of the inkjet print head 100 (see FIG. 5). The damper 152 having the above shape may have an advantage in that bubbles included in ink are not discharged to the nozzle 150. That is, the damper 152 having the narrowed size may have an advantage of separating bubbles from ink. However, the damper 152 may be omitted according to types of the inkjet print head 100.

The actuator 160 may include a piezoelectric element and the upper and lower electrode members. In other words, the actuator 160 may be a stacked structure in which the piezoelectric element may be disposed between the upper electrode member and the lower electrode member.

The lower electrode member may be formed on an upper surface of a vibrating plate and may be made of at least one conductive metal material. For example, the lower electrode member may be formed of two metal members made of titanium (Ti) and platinum (Pt).

The piezoelectric element may be formed on the lower electrode member. In other words, the piezoelectric element may be thinly formed on the surface of the lower electrode member by screen printing, sputtering, or the like. The piezoelectric element may be made of a piezoelectric material. For example, the piezoelectric element may be made of a ceramic material (for example, PZT).

The upper electrode member may be formed on an upper surface of the piezoelectric element. The upper electrode member may be made of a material such as Pt, Au, Ag, Ni, Ti, and Cu.

The actuator 160 configured as described above may be expanded and contracted according to electrical signals to generate pressure in the pressure chamber 110.

The inkjet print head 100 configured as described above may move ink from the first channel 102 to the second channel 104 by the ink supply route 130 and the ink discharge route 140, thereby reducing the blocking phenomenon of the nozzle 150 due to foreign objects or bubbles. That is, the inkjet print head according to the related art does not perform ink circulation, such that foreign objects and bubbles included in ink are discharged through a nozzle. In this case, the foreign objects and the bubbles may be concentrated on the nozzle to hinder the fixed quantity discharge or the discharge of ink itself. However, in the case of the structure in which the ink is circulated according to the embodiment of the present invention, foreign objects and bubbles are not discharged through the nozzle 150 but may be discharged via another route (that is, the second channel 104), such that the blocking phenomenon of the nozzle may not occur.

Hereinafter, further embodiments of the present invention will be described. For reference, in the embodiments described below, the same elements as those of the first embodiment of the present invention are denoted by the same reference numerals and therefore, a detailed description thereof will be omitted.

An inkjet print head according to a second embodiment of the present invention will be described with reference to FIG. 5.

The inkjet print head 100 according to the second embodiment of the present invention may be differentiated from the first embodiment in terms of the position of the ink supply route 130 and the ink discharge route 140.

In the inkjet print head 100, the ink supply route 130 may be formed below the ink discharge route 140, based on the height direction of the inkjet print head 100 (a Z-axis direction of FIG. 5). For example, a height h1 from the lower portion of the inkjet print head 100 to the ink supply route 130 may be lower than a height h2 from the lower portion of the inkjet print head 100 to the ink discharge route 140. In other words, the ink supply route 130 may be formed below the pressure chamber 110 and the ink discharge route 140 may be formed above the pressure chamber 110.

The inkjet print head 100 configured as described above may effectively discharge bubbles formed in the pressure chamber 110 to the second channel 104. That is, the bubbles included in the ink generally float upwardly, and therefore, when the ink discharge route 140 is formed above the pressure chamber 110, the bubbles may be easily discharged from the pressure chamber 110.

An inkjet print head according to a third embodiment of the present invention will be described with reference to FIG. 6.

The inkjet print head 100 according to the third embodiment of the present invention may be differentiated from the foregoing embodiments in terms of additionally including elements for removing foreign objects and bubbles. In other words, the inkjet print head 100 may include an ink tank 10, a first filter 20, a first pump 30, a degasifier 40, a pressure damper 50, a discharge unit 60, a second filter 70, and a second pump 80.

The ink tank 10 may store ink. To this end, the ink tank 10 may have a predetermined volume. Here, the volume of the ink tank 10 may be larger than a sum of the volumes of all pressure chambers 110 formed in the inkjet print head 100.

The first filter 20 may filter foreign objects included in ink. Specifically, the first filter 20 may filter foreign objects included in the ink supplied from the ink tank 10. The first filter 20 may be formed of a porous material, a net, or the like.

The first pump 30 may be connected to the ink tank 10 and the discharge unit 60. Specifically, the first pump 30 may supply the ink of the ink tank 10 to the first channel 102.

The degasifier 40 is connected to the first pump 30 and may remove bubbles generated during an ink feeding process. Further, the degasifier 40 may include a discharge valve for discharging the bubbles separated from the ink to the outside.

The pressure damper 50 may be disposed at the outlet of the first pump 30. The pressure damper 50 may reduce a pulsation phenomenon generated by the first pump 30 to allow for a uniform flow of ink to the discharge unit 60.

The discharge unit 60 may include the first channel 102, the second channel 104, the pressure chamber 110, the nozzle 150, and the actuator 160. The discharge unit 60 configured as described above may discharge ink through the nozzle 150.

The second filter 70 may filter foreign objects from the ink discharged from the discharge unit 60. Foreign objects may not be included in the ink supplied to the discharge unit 60. However, the foreign objects remaining in the discharge unit 60 may be included in ink after the ink passes through the discharge unit 60. Therefore, the foreign objects may be removed by the second filter 70. For reference, the second filter 70 may be omitted, if necessary.

The second pump 80 may supply the recovered ink to the ink tank 10. In other words, the second pump 80 supplies the ink recovered through the second channel 104 to the ink tank 10, thereby completing the ink circulation structure.

The inkjet print head 100 configured as described above may effectively remove foreign objects and bubbles included in ink through the plurality of filters 20 and 70 and the degasifier 40, thereby effectively reducing the blocking phenomenon of the nozzle 150.

Further, the inkjet print head 100 includes the plurality of pumps 30 and 80 to continuously circulate ink, thereby improving the discharge characteristics of the nozzle 150.

An inkjet print head according to a fourth embodiment of the present invention will be described with reference to FIGS. 7 through 8.

The inkjet print head 100 according to the fourth embodiment of the present invention may be differentiated from the foregoing embodiments in terms of including a plurality of first channels 102 and 106.

The inkjet print head 100 may include a pair of first channels 102 and 106. The pair of first channels 102 and 106 may be extended in a lengthwise direction (a Y-axis direction of FIG. 8) of the inkjet print head 100. The pair of first channels 102 and 106 configured as described above may supply ink to first and second pressure chambers 110 and 120, respectively.

The second channel 104 may be formed between the pair of first channels 102 and 106. The ink discharged from the pressure chambers 110 and 120 may be recovered to the second channel 104.

Meanwhile, a driving element 200 may be provided on the upper portion of the second channel 104. The driving element 200 may be connected to a plurality of actuators 160 and 170 disposed to the left and right of the second channel 104, as illustrated in FIG. 8.

The first pressure chamber 110 and the second pressure chamber 120 may be formed between the first channels 102 and 106 and the second channel 104. Here, the first pressure chamber 110 may be supplied with ink from the first channel 102 and the second pressure chamber 102 may be supplied with ink from the first channel 106. Further, a small amount of ink, of the ink introduced into each of the pressure chambers 110 and 120, remaining undischarged through the nozzle 150, may be recovered through the second channel 104.

The inkjet print head 100 configured as described above allows two first channels 102 and 106 to use a single second channel 104, such that the space efficiency of the inkjet print head 100 may be improved. In addition, since the driving element 200 in the inkjet print head 100 may be mounted on the upper portion of the second channel 104, there is no need to provide a separate mounting space for the driving element 200.

In addition, when the driving element 200 is disposed in the second channel 104, the driving element 200 may be cooled by the recovered ink. In this case, the overheating phenomenon of the inkjet print head due to the driving element 200 may be reduced, and accordingly, the degradation of ink discharge characteristics and the change in viscosity of ink due to the overheating of the inkjet print head may be significantly reduced.

Therefore, according to the embodiments of the present invention, the size of the inkjet print head 100 may be reduced and the discharge characteristics thereof may be improved.

As set forth above, according to embodiments of the present invention, an inkjet print head and an inkjet print head assembly can continuously circulate ink, thereby improving ink discharge characteristics and efficiency.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head, comprising:
a first channel to which ink is supplied;
a second channel disposed in parallel with the first channel and recovering ink;
a pressure chamber disposed between the first channel and the second channel;
an ink supply route connecting the first channel to the pressure chamber; and
an ink discharge route connecting the pressure chamber to the second channel.

2. The inkjet print head of claim 1, wherein the ink supply route is gradually narrowed in a direction toward the pressure chamber from the first channel.

3. The inkjet print head of claim 1, wherein the ink discharge route is gradually narrowed in a direction toward the second channel from the pressure chamber.

4. The inkjet print head of claim 1, wherein the ink supply route is located below the ink discharge route within the inkjet print head.

5. The inkjet print head of claim 1, wherein the ink supply route is provided with a first structure impeding a flow of ink from the pressure chamber to the first channel.

6. The inkjet print head of claim 5, wherein the first structure is gradually expanded in a direction toward the pressure chamber from the first channel.

7. The inkjet print head of claim 1, wherein the ink discharge route is provided with a second structure impeding a flow of ink from the second channel to the pressure chamber.

8. The inkjet print head of claim 7, wherein the second structure is gradually expanded in a direction toward the second channel from the pressure chamber.

9. An inkjet print head, comprising:
a pair of first channels to which ink is supplied;
a second channel disposed between the pair of first channels and recovering ink; and
a plurality of pressure chambers disposed between the first and second channels and connected to the first and second channels, respectively.

10. The inkjet print head of claim 9, wherein an ink supply route connecting the first channel to the pressure chamber is gradually narrowed in a direction toward the pressure chamber from the first channel.

11. The inkjet print head of claim 9, wherein an ink discharge route connecting the pressure chamber to the second channel is gradually narrowed in a direction toward the second channel from the pressure chamber.

12. The inkjet print head of claim 9, wherein an ink supply route connecting the first channel to the pressure chamber is provided with a first structure impeding a flow of ink from the pressure chamber to the first channel.

13. The inkjet print head of claim 12, wherein the first structure is gradually expanded in a direction toward the pressure chamber from the first channel.

14. The inkjet print head of claim 9, wherein an ink discharge route connecting the pressure chamber to the second channel is provided with a second structure impeding a flow of ink from the second channel to the pressure chamber.

15. The inkjet print head of claim 14, wherein the second structure is gradually expanded in a direction toward the second channel from the pressure chamber.

16. The inkjet print head of claim 9, wherein an upper portion of the second channel is provided with a driving element driving an actuator.
